(19) United States
(12) Patent Application Publication
(10) Pub. No.: US 2006/0103096 A1
(43) Pub. Date: May 18, 2006

(54) SCOOTER FOLDING STRUCTURE

(76) Inventor: Ting-Hsing Chen, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/988,644

(22) Filed: Nov. 16, 2004

(51) Int. Cl. B62M 1/00

(52) U.S. Cl. 280/87.05

(57) ABSTRACT

A scooter folding structure includes a frame, a front strut, and a quick release set. The frame comprises a pair of protection boards at a front end. Each protection board has a notch and a recess on the edge. The front strut is provided with a support strut. The support strut comprises a shaft having two ends as stoppers protruding from the protection boards of the frame. The support strut further comprises a sliding part and an elastic element. By pulling the sliding part, the two ends of the shaft are linked to detach from the notches or the recesses of the protection boards so as to fold or unfold the scooter.

### FIELD OF THE INVENTION

This invention relates to a scooter folding structure, and more particularly to a scooter with a sliding part to control a shaft having two ends to depart from notches or recesses of protection boards so as to fold or unfold the scooter.

### BACKGROUND OF THE INVENTION

Scooters are widely used on the market. Most products use a quick release set as a connection shaft to insert through holes on protection boards of a frame and on a support strut of a front strut to connect the two together. However, once the quick release set is loosened, the front strut and the frame may slide or move freely and it will be difficult for a user to align the holes. The operation may even pinch the users' fingers accidentally.

### SUMMARY OF THE INVENTION

It is the primary objective of the present invention to provide a scooter folding structure, which has derived a frame and a front strut to rotate without sliding, thus changing the status of the scooter is easy and safe.

It is another objective of the present invention to provide the scooter folding structure, which is more secure.

### BRIEF DESCRIPTION OF THE DRAWINGS

FIG. 1 is an exploded view of the present invention;

FIG. 2 is a partial cross-sectional view of the present invention;

FIG. 3 is a partial cross-sectional view of the present invention in an operation; and

FIG. 4 is a partial cross-sectional view of the present invention in a folding status.

### DETAILED DESCRIPTION OF THE PREFERRED EMBODIMENT

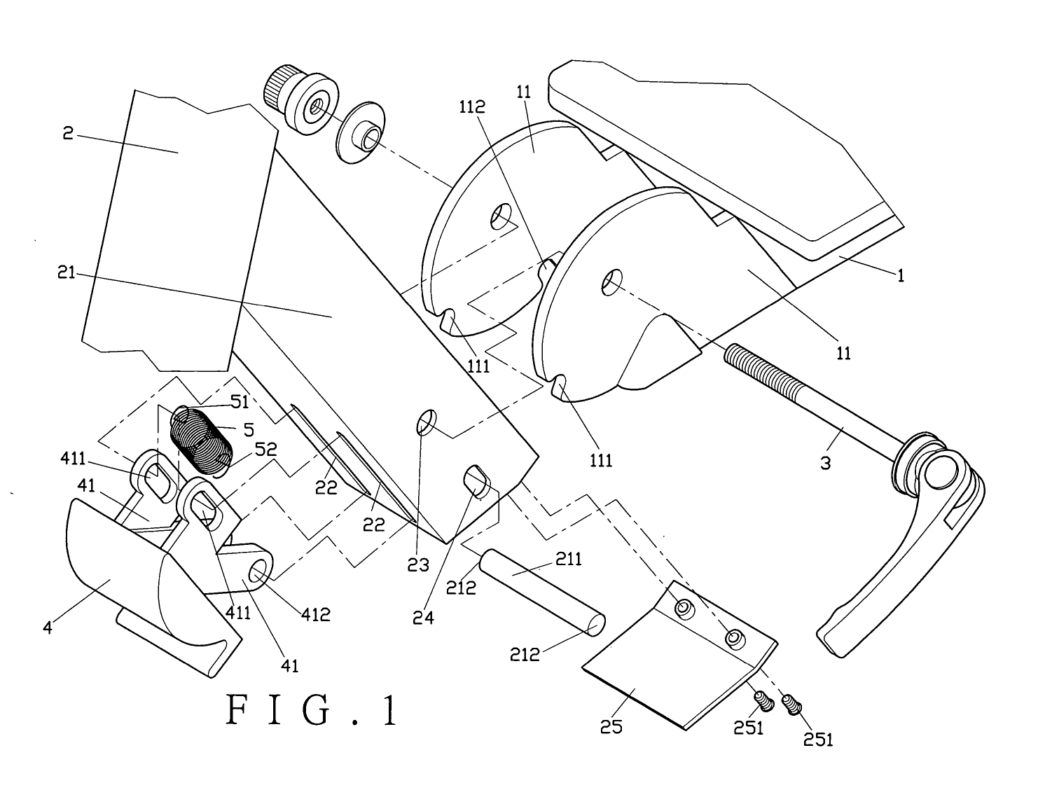

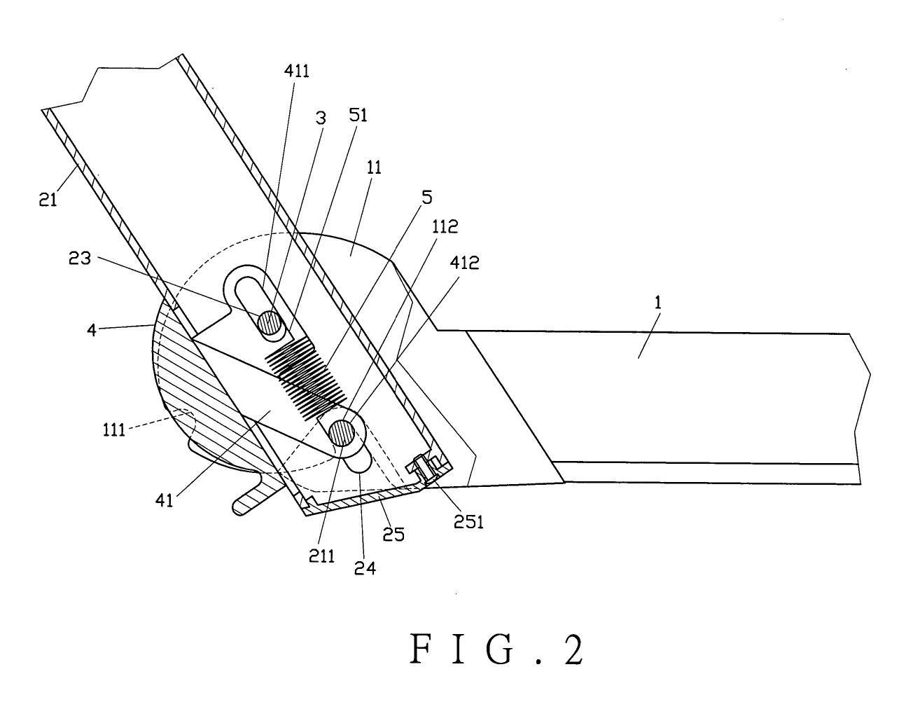

As shown in FIGS. 1 and 2, the present invention comprises a frame 1, a front strut 2, and a quick release set 3.

The frame 1 comprises a pair of protection boards 11 at the front end. Each protection board 11 has a notch 111 and a recess 112 on the edge. The front strut 2 is provided with a support strut 21. The support strut 21 includes a shaft 211 having two ends 212 as stoppers protruding from the protection boards 11. The supporting strut 21 of the front strut 2 is inserted between the protection boards 11 of the frame 1. The quick release set 3 is inserted through the protection boards 11 and the support strut 21 to secure them together. The two ends 212 of the shaft 211 are located in the notches 111 of the protection boards 11. When the quick release set 3 is loosened and the support strut 21 is turned to rotate in relation to the protection boards 11, the two ends 212 of the shaft 211 will be located in the recesses 112 of the protection boards 11. Thus the scooter is in a folding status.

The support strut 21 further comprises a sliding part 4 and an elastic element 5. The sliding part 4 comprises a pair of slanting plates 41. Each slanting plate 41 has a slot 411 and a through hole 412. The support strut 21 is provided with a pair of lengthwise slots 22 for insertion of the slanting plates 41 of the sliding part 4. The support strut 21 further comprises a pair of through holes 23 and a pair of slots 24 corresponding to the slots 411 and the through holes 412 of the slanting plates 41, respectively. The elastic element 5 has two ends 51 and 52.

The bottom end of the support strut 21 is provided with a cover 25 secured by bolts 251 thereat.

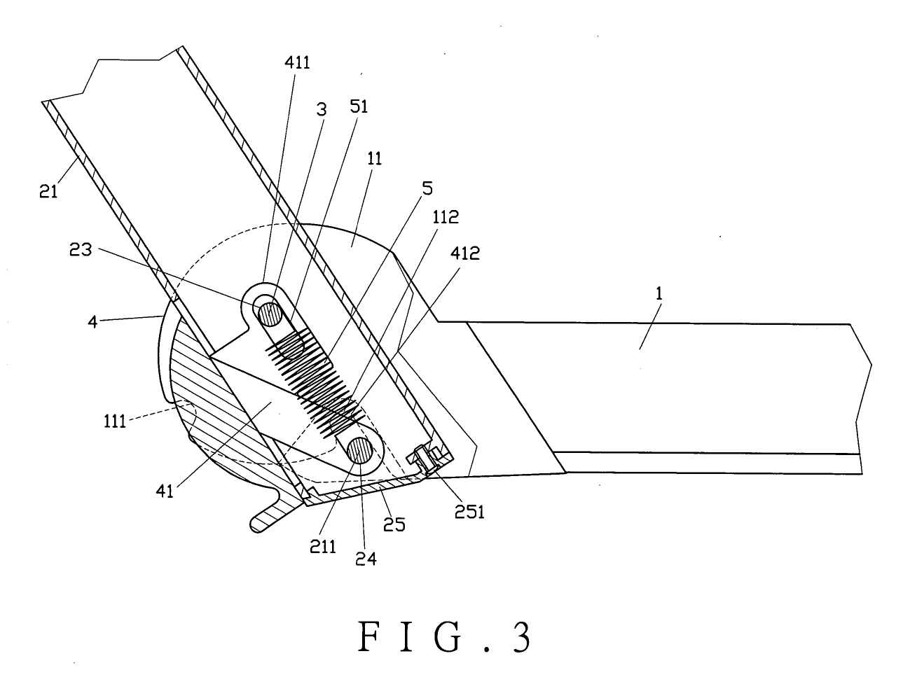

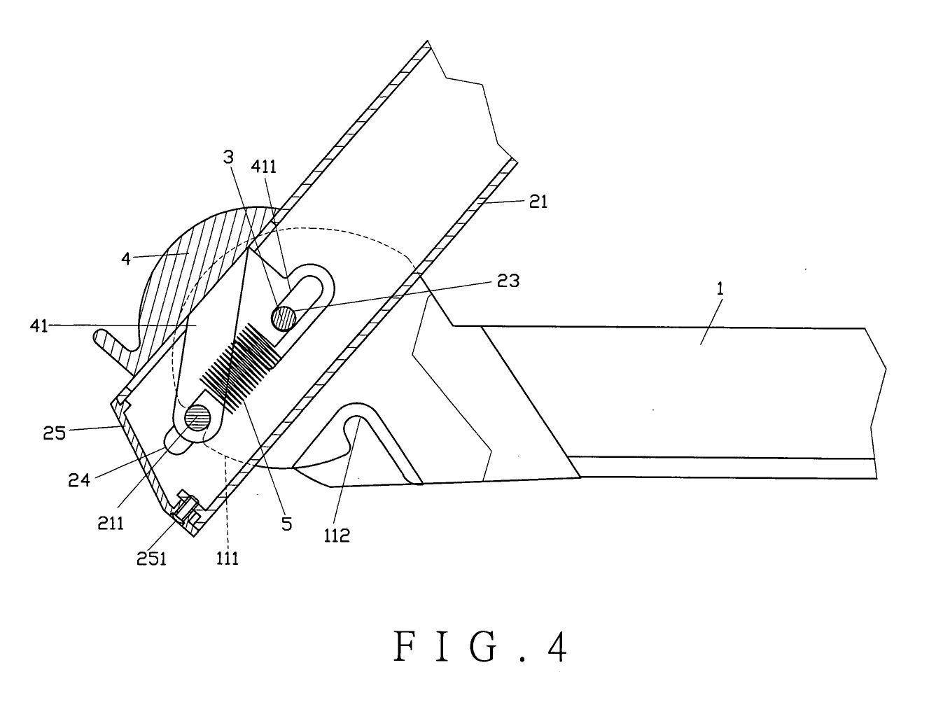

To assemble the present invention, as shown in FIG. 3, the quick release set 3 is inserted through the protection boards 11, the through holes 23 of the support strut 21 of the front strut 2 and the slots 411 of the slanting plates 41 of the sliding part 4 and secured with one end 51 of the elastic element 5. The shaft 211 is inserted through the slots 24 of the support strut 21 of the front strut 2 and the through holes 412 of the slanting plates 41 of the sliding part 4, and then secured with another end 52 of the elastic element 5. By pulling the sliding part 4, as shown in FIG. 4, the slanting plates 41 of the sliding part 4 will link the shaft 211 to move and depart from the notches 111 or the recesses 112 of the protection boards 11.

What is claimed is:

1. A scooter folding structure comprising a frame, a front strut and a quick release set, said frame comprising a pair of protection boards at a front end, each said protection board comprising a notch and a recess, said front strut comprising a support strut secured between said protection boards of said frame with said quick release set, said support strut comprising a shaft having two ends as stoppers protruding from said protection boards of said frame, said two ends of said shaft being positioned in said notches of said protection boards, and characterized in that:
said front strut further comprising a sliding part and an elastic element, said sliding part comprising a pair of slanting plates, each slanting plate comprising a slot and a through hole thereon, said support strut of said front strut comprising a pair of lengthwise slots for insertion of said slanting plates of said sliding part, said support strut of said front strut further comprising a pair of through holes and a pair of slots corresponding to said slots and said through holes of said slanting plates of said sliding part, respectively, said elastic element having two ends, thereby said quick release set being inserted through said through holes of said support strut of said front strut and said slots of said slanting plates of said sliding part and secured with one end of said elastic element, said shaft being inserted through said slots of said support strut of said front strut and said through holes of said slanting plates of said sliding part and secured with another end of said elastic element.
